(19) United States
(12) Patent Application Publication
(10) Pub. No.: US 2020/0167726 A1
(43) Pub. Date: May 28, 2020

(54) SYSTEM METHOD FOR PROVIDING INTEGRATED UNLOADING AND LOADING PLANS USING CLOUD SERVICE

(71) Applicant: TOTAL SOFT BANK LTD., Busan (KR)

(72) Inventors: Hoon LEE, Busan (KR); Taeheun KIM, Busan (KR); Chaemin LEE, Busan (KR); Jiheon CHAE, Jeju-si (KR)

(73) Assignee: TOTAL SOFT BANK LTD., Busan (KR)

(21) Appl. No.: 16/063,147

(22) PCT Filed: Dec. 14, 2016
(86) PCT No.: PCT/KR2016/014622

§ 371 Date: Jun. 15, 2018

(30) Foreign Application Priority Data
Dec. 17, 2015 (KR) 10-2015-0180857
Dec. 30, 2015 (KR) 10-2015-0190069
Mar. 11, 2016 (KR) 10-2016-0029493

(51) Int. Cl. G06Q 10/08

(52) U.S. Cl. CPC G06Q 10/0835; B65G 67/60; G06Q 10/0831; G06Q 10/0832

(57) ABSTRACT

A cloud service system and method for unloading and loading plans are disclosed. The system includes a server and planners. An integrated unloading plan providing method includes the operation: (a) assigning, by each planner, a ship company, a sea route, and a ship for an unloading plan; (b) specifying, by each planner, edition attributes in consideration of the attributes of cargo to be loaded; (c) performing, by each planner, display for each cell of a bay profile on the basis of the previously specified cargo attributes; (d) when there is a need to input detailed information for each cell of the bay profile, inputting, by each planner, the detailed information; (e) when there is a need for inboard transloading during an operation for each cell, assigning, by each planner, a transloading plan to a corresponding cell; and (f) determining, by each planner, whether planning for each cell has been completed.

### TECHNICAL FIELD

The present invention relates to a system and method for providing an integrated stowage plan using a cloud service, and more particularly, to a system and method for providing integrated stowage plan using a cloud service that allow a plurality of planners to share the stowage plan required for unloading of containers from a ship through the cloud service and allow planner-side terminals related to unloading and loading of containers to integrally make a predetermined stowage plan using a web browser or mobile device.

### BACKGROUND ART

Generally, a shipping company provides a container transportation service by constructing a fleet of a plurality of ships belonging to the shipping company such that the ships can be operated on the basis of the routes connecting the ports to transport containers and provide a liner service for each transit port.

The shipping company also provides related services such as shipping reservation, arrival report, shipping plan, shipment entry, inspection, planning and execution of unloading & loading and transportation of each container for each port through which a ship passes.

In other words, as shown in FIG. 1, in a typical container terminal, the shipping company establishes a stowage plan in consideration of the unloading & loading work for a container ship at each port, the inspection company carries out inspection of the stowage plan and unloading & loading work, and the operator establishes an unloading & loading plan for the container ship and then carries out and manages the corresponding loading & loading work using port equipment. The unloaded container is delivered through a carrier at the request of the owner.

For example, as shown in FIG. 2, a shipping company and an operator using a container terminal configure a separate system to be operated, respectively, to manage a stowage plan. The inspection company operates a separate system or carries out the loading work based on a document printed out through the system of the shipping company or the operator.

In other words, a stowage plan is established through a “planner” belonging to the shipping company in consideration of import and export cargoes for each port and relevant information is transferred to the chief officer and the operator.

The “chief officer” establishes a stowage plan for the cargo, taking into account the safety of the ship.

The “chief inspector” of the inspection company compares the list of the shipping company's customs declaration with the stowage plan of the ship. If the list is different from the stowage plan, the inspector contacts the shipping company, establishes an action plan for special cargo and confirms the work plan after review by the first mate.

The confirmed result is passed on to the planner belonging to the operator, and the operator/planner plans arrangement of port equipment and an execution sequence of the unloading & loading work.

The plan is delivered to a person in charge of unloading & loading and an equipment operator in the operation company and the inspector belonging to the inspection company, and the unloading & loading work is executed. The result of execution of the work is reported to the shipping company and related organizations through persons in charge at the operation company and the inspection company.

However, in the conventional system and method for providing a stowage plan, the shipping company, the inspection company, and the operator individually construct a stowage planning system, individually generate and manage information, and exchange stowage planning data through EDI (electronic data interchange) or a recording medium. In the case of occurrence of an exceptional event such as a change in plan during exchange of data between or operation of the stowage planning systems, measures are not taken in real time, and at the same time, work according to the stowage plan is delayed.

Moreover, manual stowage planning, which is complex and difficult and is important from the viewpoint of the stowage planning work because the unloading & loading plan affects operational efficiency such as a ship schedule and cargo delivery, takes a great deal of manpower and time. Therefore, there is a need for development of a solution for an integrated automatic stowage plan to optimize the stowage plan to reduce design time and improve stability of the ship based on operational concepts and practices. Nevertheless, conventional “stand-alone” computer software that supports creation of an unloading & loading plan for a container ship is software that is independently installed on the user's computer, and therefore the user environment is limited to the Windows OS, the software to be used should be installed in advance, and changing the software requires a re-installation process.

In addition, if a standard code associated with an object-to-be-planned, route information about a ship to be planned, or specification information about the ship to be planned does not exist when presence thereof is checked by a planner, the planner is required to register and manage the missing information. In addition, the planner is conventionally required to laboriously acquire an EDI file (for example, BAPLIE, etc.) of an object subjected to the stowage plan electronically, for example, by e-mail, FTP, or the like to prepare for a task by reading the existing stowage plan information (BAPLIE, i.e.) or generating a new stowage plan. Further, after the planner completes the planning work, the planner is required to store the results one by one and to transmit the results of the unloading & loading plan to the EDI file (for example, BAPLIE, etc.).

### DISCLOSURE

### Technical Problem

Therefore, the present invention has been made in view of the above problems, and it is one object of the present invention to provide a system and method for providing an integrated stowage plan using a cloud service that allow terminals of a shipping company, an inspection company and an operator to share a list of stowage plans necessary for unloading of containers from a ship through a cloud service such that user terminals associated with loading of the container can be provided with a predetermined integrated stowage plan.

Further, the system and method for providing an integrated stowage plan using a cloud service according to the present invention are a web service-type service technique of stowage plans, which is directed to an online service method using online subscription using a standard web browser and mobile device.

These and other objects of the present invention will be apparent to those skilled in the art from the appended claims without departing from the technical spirit of the present invention.

### Technical Solution

In accordance with one aspect of the present invention, provided is a system for providing an integrated stowage plan using a stowage planning cloud service (SPCS), the system including a server 200 of an SPCS system for providing standard code information, ship route information, ship specification information, and an EDI transmission/reception service; a first planner 140 connected to the server 200 via a web browser or mobile device; and a second planner 140′ different from the first planner 140 connected to the server 200 via the web browser or mobile device, wherein each of the first planner 140 and the second planner 140′ performs a series of operations including (a) specifying a shipping company, a route, and a ship subjected to a stowage plan (S61); (b) specifying, by each of the planners, an editing attribute in consideration of attributes of a cargo to be loaded (S62); (c) displaying, by each of the planners, a bay profile in units of a cell of the bay profile based the specified cargo attribute (S63); (d) when input of detailed information is needed in units of the cell of the bay profile, inputting and processing, by each of the planners, detailed information (S64); (e) when in-ship shift is needed during work in units of the cells, specifying, by each of the planners, a shift plan in a corresponding cell (S65); (f) determining, by each of the planners, whether or not a cell-by-cell plan has been completed (S66); (g) repeating the operations from the step S62 when the plan has not been completed, and inspecting stowage plan information when the plan has been completed (S67); (h) determining whether there is a problem in the inspection (whether the stowage plan has been completed) (S68); (i) repeating the operations from the step S62 when there is a problem in the step (h) (the stowage plan has been completed), and storing and registering, by each of the planners, a result of execution of planned when there is no problem in the step (h) (the stowage plan has been completed) (S69).

In accordance with another aspect of the present invention, provided is a method for providing an integrated stowage plan using a stowage planning cloud service (SPCS) system including a server 200 and a plurality of planners (140, 140′), with standard code information, ship route information, ship specification information and an EDI transmission/reception service provided by the server 200 of the SPCS system, the method including (a) specifying, by each of the planners 140, 140′, a shipping company, a route, and a ship subjected to a stowage plan (S61); (b) specifying, by each of the planners, an editing attribute in consideration of an attribute of a cargo to be loaded (S62); (c) displaying, by each of the planners, a bay profile in units of a cell of the bay profile based the specified cargo attribute (S63); (d) when input of detailed information is needed in units of the cell of the bay profile, inputting and processing, by each of the planners, detailed information (S64); (e) when in-ship shift is needed during work in units of the cells, specifying, by each of the planners, a shift plan in a corresponding cell (S65); (f) determining, by each of the planners, whether or not a cell-by-cell plan has been completed (S66); (g) repeating steps from the step S62 when the plan has not been completed in the step (h), and inspecting, by each of the planners, stowage plan information when the plan has been completed in the step (f) (S67); (h) determining whether there is a problem in the inspection (whether the stowage plan has been completed) (S68); and (i) repeating steps from the step S62 when there is a problem in the step (h) (the stowage plan has been completed), and storing and registering, by each of the planners, a result of execution of planned when there is no problem in the step (h) (the stowage plan has been completed) (S69).

Preferably, the step (b) (S62) includes (b1) selecting a container loading place (S71); (b2) selecting a container unloading place (S72); (b3) selecting a secondary container unloading place (S73); and (b4) selecting a shipping company (S74).

Preferably, the step (c) (S63) includes (c1) selecting a Plan work mode or a View work mode (S75); (c2) selecting a size of a container (S76); and (c3) deleting slot information (S77).

More preferably, the step (c1) includes supporting switch use of a bay view area between the Plan mode and the View mode (S75-1); supporting a plan in units of bay View cells (S75-2); supporting, in the View mode, an information view in units of bay view cells and displaying “Cell Information View” (S75-3).

Preferably, the step (d) includes (d1) inputting detailed information on a dangerous cargo (S81); (d2) inputting information exceeding container standard dimensions (S82); (d3) inputting special precautions related to container handling (S83); and (d4) inputting bundle container and non-standard cargo information (S84).

More preferably, the step (d2) includes supporting input of a dimension value of a cargo exceeding the container standard dimensions (S82-1); inputting, in a “Dimension” field, a dimension value of an item exceeding the container standard dimensions (S82-2); and supporting, in a “Slot (Units)” field, automatic display and correction of the number of in-ship occupied cells (slots) by the exceeding dimension (S82-3).

Preferably, the step (e) includes (e1) calling a container shift plan information screen (Shift Container List) (S91); (e2) selecting a Collect Shift Container button and selecting a container to be shifted (S92); (e3) selecting the container to be shifted in the Shift Container List (S93); and (e4) selecting a shift position by selecting a Set New Position button (S94).

In accordance with another aspect of the present invention, provided is a system for providing an integrated loading plan using a cloud service, the system including a first unloading & loading plan execution group 101 for executing a loading plan, including a master planner terminal 110, the chief officer terminal 120, the chief inspector terminal 130, the operation planner terminal 140, the operation personnel terminal 150, and the equipment operator terminal 160 and the operation inspector terminal 170; a plurality of stowage plan execution groups 102 to 105 having the same configuration as the first stowage plan execution group 101; and a cloud service server 200 configured to collect stowage plans transmitted from the first stowage plan execution group 101 and the plurality of stowage plan execution groups 102 to 105 and provide a predetermined integrated stowage plan related to loading of a container such that the stowage plans executed at each port and data according to the execution can be shared and utilized.

Preferably, at least one of the stowage plan execution groups implements a method for providing an integrated loading plan using a cloud service using a stowage planning cloud service (SPCS) including a terminal operating system (TOS).

In accordance with another aspect of the present invention, provided is a method for providing an integrated stowage plan using a cloud service using a stowage planning cloud service (SPCS), the method including (a) registering, in the SPCS, a “stowage plan” established by a shipping company planner based on a container transportation reservation from a master planner terminal 110 (S1); (b) receiving review and correction for a special cargo to be unloaded input by a chief inspector in the SPCS, from a chief inspector terminal 130 (S2); (c) receiving, from a chief officer terminal 120, an input result of review of navigation stability of a ship and a shipping position by a chief officer in the SPCS; (f) registering the “stowage plan” determined by a chief inspector in SPCS (S6); (g) establishing and registering an “unloading & loading work plan” from the “stowage plan” in the SPCS by a terminal planner from an operation planner terminal 140 after the step (f) (S7); (h) supporting an operation personnel terminal (150) such that operation personnel and equipment operators can perform unloading & loading work based on the “unloading & loading work plan” using a terminal operating system (TOS) (S8); (i) supporting an operation inspector terminal 170 to allow inspectors to inspect individual unloaded containers and to register individual “unloading & loading work results” in the SPCS, and notifying the chief inspector terminal 130 of the results (S9); and (j) supporting the operation inspector terminal 170 to register a result of collection and organization of the “unloading & loading work results” by the chief inspector in the SPCS and notifying a chief officer terminal 120 and the master planner terminal 110 of the registration.

Preferably, the method further includes (d) checking whether loading position adjustment is needed after the step (c) (S4), wherein, when it is determined that the adjustment is needed as a result of the determination in the step (d), the method returns to the step (b), wherein, when it is determined that the adjustment is not needed, the method proceeds to a next step.

More preferably, the method further includes (e) determining whether or not there is a cargo that cannot be shipped after the step (d) (S5); wherein, when it is determined that there is a cargo that cannot be shipped, method returns to the step (a), wherein, when it is determined that there is no cargo that cannot be shipped, the method proceeds to a next step.

### Advantageous Effects

According to the present invention, a system and method for providing an integrated stowage plan using a cloud service allow terminals of a shipping company, an inspection company and an operator to share a list of stowage plans necessary for unloading/loading of containers of a ship through a cloud service such that user terminals associated with loading of the containers can be provided with a predetermined integrated stowage plan. Thereby, a delay in operation may be prevented in execution of the stowage plans.

Furthermore, there is no restriction on the OS of the user environment, and it is possible to access the web without requiring installation of software. In addition, the reinstallation process is unnecessary when the software is changed.

That is, a service provider can autonomously manage, through a “stowage planning cloud service system” (hereinafter, SPCS), a “standard code information providing service,” a “ship route information providing service,” a “ship specification information providing service” and an “EDI transmission/reception service,” and a user (planner) can go online through a web browser to use a related service without installation and maintenance of a separate program. In addition, the user (planner) does not need to be involved in management of information such as the “standard code,” “ship route,” “ship specifications,” and “EDI transmission/reception”, but only needs to conduct “marking cargo attributes on a cell basis,” “specifying a transfer plan on a cell basis” and “preliminary inspection of the stowage plan,” which are planned tasks.

Additional features and advantages of the present invention will become more apparent from the following description.

### DESCRIPTION OF DRAWINGS

FIG. 1 is a view illustrating an unloading & loading operation at a typical container terminal.

FIG. 2 is a diagram schematically showing the configuration of the system of FIG. 1.

FIG. 3A is a diagram illustrating a configuration of a system for providing an integrated stowage plan using a cloud service according to one aspect of the present invention.

FIG. 3B is a diagram illustrating a flow of unloading and loading according to the system for providing an integrated stowage plan using a cloud service according to one aspect of the present invention.

FIG. 3C is a flowchart illustrating a method for providing an integrated stowage plan using a cloud service according to an aspect of the present invention.

FIG. 4 is a diagram illustrating an exemplary configuration of an integrated operation of a cloud service server applied to the present invention.

FIG. 5 illustrates a difference between an existing system and a related system of the present invention.

FIG. 6 is a diagram illustrating a flow of unloading and loading according to a system for providing an integrated stowage plan using a cloud service according to another aspect of the present invention.

FIG. 7A is a flowchart illustrating a method for providing an integrated stowage plan using a cloud service according to another aspect of the present invention.

FIG. 7B is a detailed flowchart of a cargo attribute designation step S62 of FIG. 7A.

FIG. 7C is a detailed flowchart of a cargo attribute display step S63 of FIG. 7A.

FIG. 7D is a detailed flowchart of a detailed information input step S64 of FIG. 7A.

FIG. 7E is a detailed flowchart of a transfer plan designation step S65 of FIG. 7A.

FIGS. 8A to 8C show an example of a preliminary preparation step in an actual screen configuration of a system for providing an integrated stowage plan using a cloud service according to an aspect of the present invention.

FIG. 9 is a functional block diagram illustrating respective windows for a stowage plan in a system for providing an integrated stowage plan using a cloud service according to another aspect of the present invention.

FIG. 10 is a diagram illustrating a module hierarchy for respective windows for a stowage plan in a system for providing a integrated stowage plan using a cloud service according to another aspect of the present invention.

FIGS. 11A to 11D are detailed views illustrating each step for GBV of FIG. 10.

FIGS. 12A to 12E are detailed views illustrating each step for CIV of FIG. 10.

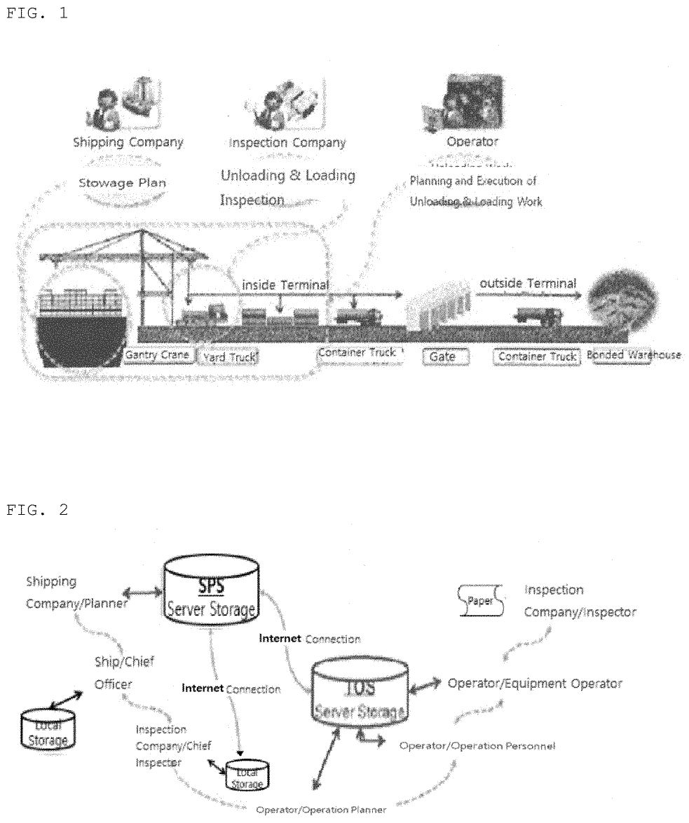

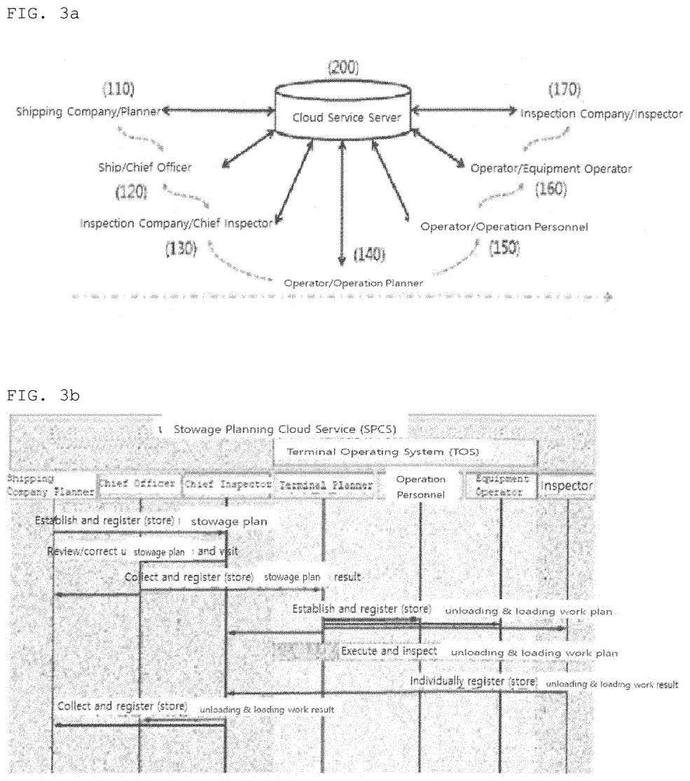

### BEST MODE

Hereinafter, a system and method for providing an integrated stowage plan using a cloud service according to a preferred embodiment of the present invention will be described in detail with reference to the accompanying drawings.

Wherever possible, the same reference numbers will be used throughout the drawings to refer to the same or like parts. A detailed description of well-known functions and constituents will be omitted if it is determined that such description can unnecessarily obscure the main points of the present invention.

In this specification, the embodiments described above should be construed in all aspects as illustrative and not restrictive. It will be apparent to those skilled in the art that various modifications and variations can be made in the present invention without departing from the spirit and scope of the invention. Thus, it is intended that the present invention cover the modifications and variations of this invention provided they come within the scope of the appended claims and their equivalents.

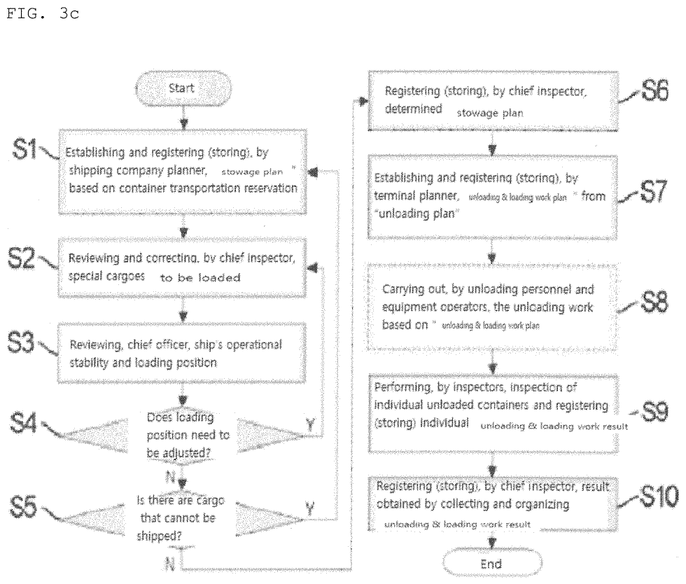

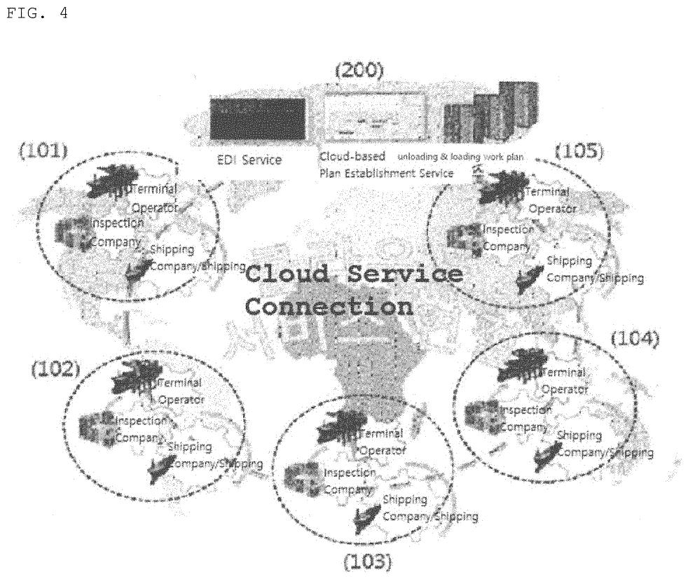

Hereinafter, a system and method for providing an integrated stowage plan using a cloud service according to an embodiment of the present invention will be described with reference to FIGS. 3A to 5.

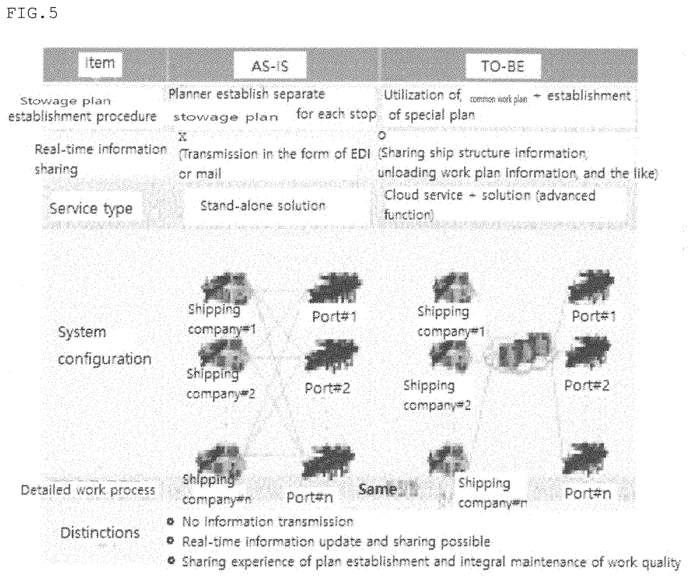

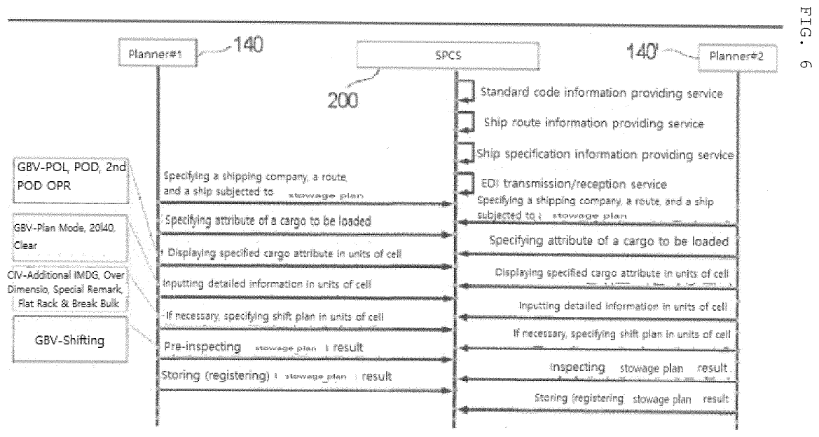

FIG. 3A is a diagram illustrating a configuration of a system for providing an integrated stowage plan using a cloud service according to one aspect of the present invention, and FIG. 3B is a diagram illustrating a flow of unloading and loading according to the system for providing an integrated stowage plan using a cloud service according to one aspect of the present invention. FIG. 3C is a flowchart illustrating a method for providing an integrated stowage plan using a cloud service according to an aspect of the present invention. FIG. 4 is a diagram illustrating an exemplary configuration of an integrated operation of a cloud service server applied to the present invention. FIG. 5 illustrates a difference between an existing system and a related system of the present invention.

As shown in FIG. 3A, a system for providing an integrated stowage plan using a cloud service according to one aspect of the present invention includes a master planner terminal 110, a chief officer terminal 120, a chief inspector terminal 130, an operation planner terminal 140, an operation personnel terminal 150, an equipment operator terminal 160, an operation inspector terminal 170, and a cloud service server 200.

Specifically, the master planner terminal 110 establishes a stowage plan in consideration of the import and export cargoes for each port through a planner belonging to the shipping company, and transmits related information to the chief officer terminal 120 and the cloud service server 200.

The chief officer terminal 120 establishes a stowage plan for the cargoes considering the safety of the ship and transmits the established plans to the chief inspector terminal 130 and the cloud service server 200.

Before the unloading & loading work, the chief inspector terminal 130 compares the list of the shipping company's customs declaration with the stowage plan of the ship. If the list is different from the stowage plan, the chief inspector terminal contacts the shipping company, establishes a work plan for special cargo, and transmits the established plan to the operation planner terminal 140 and the cloud service server 200.

The operation planner terminal 140 establishes a plan for arrangement of port equipment and an execution sequence of the unloading & loading work, and transmits the plan to the operation personnel terminal 150 and the cloud service server 200.

The operation personnel terminal 150 transmit information according to execution of loading work to the equipment operator terminal 160 and the cloud service server 200 such that the loading work can be performed according to the plan transmitted from the operation planner terminal 140.

The equipment operator terminal 160 performs the unloading & loading work transmitted from the operation personnel terminal 150 and transmits the result of execution of the loading work to the operation inspector terminal 170 and the cloud service server 200.

The operation inspector terminal 170 checks whether the loading work transmitted from the equipment operator terminal 160 is consistent or not, transmits the result of checking to the cloud service server 200 such that the shipping company and a related organization can recognize the result.

The cloud service server 200 collects stowage plans transmitted from the master planner terminal 110, the chief officer terminal 120, the chief inspector terminal 130, the operation planner terminal 140, the operation personnel terminal 150, the equipment operator terminal 160 and the operation inspector terminal 170 and allows the terminals related to loading of a container to receive a predetermined integrated stowage plan such that the terminals can share and utilize loading work plans executed at the respective ports and data according to the execution.

That is, as shown in FIG. 4, when the master planner terminal 110, the chief officer terminal 120, the chief inspector terminal 130, the operation planner terminal 140, the operation personnel terminal 150, and the equipment operator terminal 160 and the operation inspector terminal 170 are configured as a first stowage plan execution group 101, the cloud service server 200 can integrally manage a plurality of other stowage plan execution groups 102, 103, 104, and 105 which executes the same loading work plan as the first stowage plan execution group 101.

For reference, in this specification, the master planner terminal 110, the chief officer terminal 120, the chief inspector terminal 130, the operation planner terminal 140, the operation personnel terminal 150, the equipment operator terminal 160 and the operation inspector terminal 170 described above have the same meaning as the planner of the shipping company, the first mate, the chief inspector, the terminal operation planner, the operation personnel, the equipment operator and the inspector, respectively.

Hereinafter, a method for providing an integrated stowage plan using a cloud service according to one aspect of the present invention will be described with reference to FIGS. 3B and 3C. A system and method for providing an integrated stowage plan using a cloud service according to one aspect of the present invention includes the existing terminal operating system (TOS) and a stowage planning cloud service system (SPCS), which is an extended version of the stowage planning system (SPS).

In other words, in the process from draft/review of an “stowage plan” to draft/execution/report of the “unloading & loading work plan”, 1) the planner of the shipping company establishes a “stowage plan”, and registers (stores) the established plan in the SPCS, 2) the chief inspector checks the “stowage plan” from the SPCS, and reviews, modifies and supplements a part of the plan for special cargo, 3) the chief inspector receives the review of the “stowage plan” from the chief officer online and confirms the plan, 4) the “stowage plan” confirmed by the chief inspector is registered (stored), 5) the terminal planner establishes an “unloading & loading work plan” based on the “stowage plan”, and registers (stores) the established plan in the SPCS, 6) the operation personnel and the equipment operators perform the unloading & loading work (unloading, loading, transshipment, transfer, etc.) based on the “unloading & loading work plan”, and the operation inspectors perform inspection activities (omitting explanation such as self-reporting in the terminal), 7) individual inspectors delivers a report (notification) to the chief inspector by registering (saving) the “unloading & loading work result” they have checked in the field, and 8) the chief inspector delivers a report (notification) to the chief officer and shipping company planner by collecting and registering (saving) the “unloading & loading work results”.

The work described above is repeatedly performed at the port where the ship enters (e.g., Osaka Port, Busan Port, Kaohsiung port, etc.) from the time before the ship enters to the time after the ship leaves.

Referring to FIG. 3C, the procedure of drafting, reviewing, checking, and reporting an “stowage plan” using the stowage planning cloud service (SPCS) is performed as follows. 1) When the master planner of the shipping company registers (stores) the “stowage plan” established based on the container transportation reservation in the SPCS (S1), a review and correction for special cargo to be unloaded is input to the SPCS by the chief inspector based on the stowage plan (S2), and 3) review of the ship's operational stability and loading position, and the result of review by the chief officer is input to the SPCS by the chief officer (S3). Then, an action such as adjustment of loading position or cancellation of loading is taken, and therefore it is first checked whether or not the loading position needs to be adjusted (S4). If it is determined that adjustment is needed, the process returns to step S2. If it is determined that adjustment is not needed, it is determined if there is a cargo that is not loadable. If there is a cargo that is not loadable, the process returns to step S1. If not, 4) the “stowage plan” confirmed by the chief inspector is registered (stored) in the SPCS (S6). 5) Thereafter, the terminal operation planner establishes and registers (stores) the “unloading & loading work plan” based on the “stowage plan” in the SPCS (S7), 6) the terminal operation personnel and the equipment operators are supported so as to use the TOS to carry out the unloading & loading work based on the “unloading & loading work plan” (S8). 7) At this time, operation inspectors perform inspection of individual unloaded/loaded containers and register (store) the individual “unloading & loading work results” in the SPCS (S9). 8) A result obtained by collecting and organizing the “unloading & loading work results” is registered (stored) in the SPCS by the chief inspector (S10).

The above operations are also repeatedly performed at the port where the ship enters (e.g., Osaka Port, Busan Port, Kaohsiung port, etc.) from the time before the ship enters to the time after the ship leaves.

Hereinafter, a description will be given of a system and method for providing an integrated stowage plan using a cloud service according to an aspect of the present invention (hereinafter referred to as a “stowage planning system and method”) in comparison with a conventional scheme. In the conventional scheme, the shipping company, the inspection company and the operator individually configure a system, and thus individually generate and manage information and exchange data with each other through the EDI or a recording medium. Accordingly, when an exceptional event such as change of the plan during data exchange and work, a measure is not immediately taken, and work delay is caused. On the other hand, the stowage planning system and method configure a single system for the individual systems focusing on the loading/unloading & loading work, and configure and execute a global service by integrating systems necessary for the respective ports. Thus, the unloading & loading work plans and experiences according to execution of the unloading & loading work plans can be shared.

In other words, as shown in FIG. 5, in the process of establishing a stowage plan, 1) the conventional system requires planners to separately establish an unloading & loading work plan at each stop, but the “stowage planning system and method” only needs to utilize a common work plan and establish a special plan. 2) In sharing information in real time, the conventional technology transmits information in the form of EDI or an email, but the “stowage planning system and method” allow ship structure information, unloading & loading work plan information, and the like to be shared. 3) In the service type, the conventional technology adopts a standalone solution, but the “stowage planning system and method” uses a combination of a cloud service and a solution method. 4) Furthermore, “stowage planning system and method” enables information to be updated and shared in real time as there is no information transfer activity, and also enables experiences of plan establishment to be shared and work qualities to be maintained in a batch.

Therefore, according to the “stowage planning system and method”, it is expected to improve work efficiency through the stowage planning system integration service required by individual shipping companies, operators, and inspection companies. When an exceptional event such as change of a plan during data exchange or work, taking an immediate action is facilitated. In addition, as a global service is configured by integrating systems necessary at the respective ports and is provided for each port, experiences obtained from planning and performing unloading & loading work can be shared between the companies. Thus, when an exceptional event occurs at a port during unloading & loading work immediately before a ship enters the port, the event can be recognized and coped with in advance. Therefore, work productivity is expected to be improved. Further, it easy to provide a supplementary service as a single platform for “arrival report, a stowage plan, cargo declaration, inspection and unloading & loading plan” for container ships is configured.

For reference, as used herein, the term “stowage plan” refers to a drawing showing arrangement of cargo loaded on a dock of a ship, and the term “cargo manifest” refers to a list of cargo loaded on a vessel or aircraft.

The “shipping company/master planner” is a person in charge of an stowage plan belonging to the ship operator.

“Ship sailors” include “sailors” and “chief officers.” The “sailor” establishes a stowage plan for the cargo considering the safety of the ship, supervises unloading & loading work in consideration of securing adequate dynamic stability and hull strength and stone, sand, sea water, etc. loaded at the bottom of the ship to lower the related ballast balance (the center of gravity of the ship) to increase dynamic stability, and checks the fixed condition of cargoes. In the case of oil tankers, the sailor fills in the oil record. In addition, the chief officer (CO), who is an officer taking the highest position next to the captain among crew on board, assists the captain, is responsible for directing and supervising the sailors and deck hands and acts as a delegate in the absence of the captain as the officer in charge of the deck department. As the chief officer assists the captain and is responsible for directing sailors according to the commands of the captain and supervising all work on deck, especially for taking over loading, storing and management of cargo, he performs (1) management of ship safety, discipline and sanitation, (2) creation of a cargo stowage plan, supervision of unloading and management of cargo safety, (3) deck staff work and instructions and personnel management, (4) maintenance and supervision of each part of the hull, (5) creation and management of documents about the deck department, and (6) operation and management of drinking water, ballast, bilge, and (7) operations at the bow part at the time of entry and departure.

The “chief inspector” refers to “a chief responsible for container inspection” (chief inspector)”. In order to perform the shipping work (loading or unloading of cargo directly onto or from the ship with the ship docked), the “chief responsible for container inspection” compares the stowage plan (a drawing showing arrangement of cargo loaded on the deck of the ship) with the cargo manifest (a list of cargo loaded on a ship or an aircraft), fills out a work log book, instructs inspectors to perform inspection, and compares the checklist created by the container inspector with the cargo manifest. If the list is different from the cargo manifest, the chief inspector will prepare a report on abnormality of the unloading/loading result and send the report to customs and the shipping company, prepare a container damage report and obtain signature approval in consultation with a sailor. Alternatively, the “chief inspector” may make a list of frozen containers.

The “operation planner” refers to an “unloading/loading planner” or a “container planner”. First, the “unloading/loading planner” “receives information on unloading and loading from the owner or a shipping company by exchanging e-mails or electronic documents, examines the unloading and loading profiles, negotiates and reconciles a schedule with the owner or the shipping company, inputs the information on the unloaded or loaded container to the database, carries out the stowage planning of the ship work in the stowage planning system, checks the order of unloading to check and modify particular details, checks and revises the number of frozen containers, special containers, dangerous goods, transshipment containers, and line-specific containers by printing out the details of the order of unloading, establishes an unloading bay plan, prints out the final reviewed bay plan, work order and details of work, prepares an unloading work document and delivers the document to the terminal operator in the control center. In addition, the operation planner performs stowage planning of the ship work in the stowage planning system, checks the order of loading to check and modify particular details, checks and revises the number of frozen containers, special containers, dangerous goods and transshipment containers by printing out the details of the order of loading, establishes a loading bay plan, prints out the final reviewed bay plan, work order and details of work, prepares a loading work document and delivers the document to the terminal operator in the control center. In addition, when a bottleneck phenomenon or a work problem occurs at the work site during the shipping operation, the chief inspector revises the bay plan in consultation with the shipping company, and then passes the revised plan to the terminal operator in the Control Center.

In addition, the “container planner” makes a loading assignment table by checking the crane operation situation or the like, allocates berths, adjusts the container crane allocation time, readjusts the berth allocation schedule if there is a change in the ship's port-in time or the planned quantity of items for work, establishes the unloading & loading work plans, checks a ship line arrival plan, and prepares a table of reserved berths for the ships for which berths have been confirmed, establishes the detailed device plan for each ship line such that ship unloading & loading work can be carried out in consideration of the yard situation, and manages statistics on the vessel occupancy rate and congestion related data.

The “operation personnel” includes a “foreman,” an “under man,” a “signalman,” a “container equipment dispatcher,” and a “container dock control room control man”. The “foreman” reviews the contents of a cargo unloading/loading document, establish a work plan for container cargo and various special cargo, checks safety information and educates undermen and equipment operators to prevent accidents, checks the work status of the corresponding ship line, checks damage to the ship line hull, various ship facilities and special cargo, arranges the personnel in accordance with the work setting for the ship, controls the work, controls operations of related workers, and takes action against accidents occurring during work.

The “under man” reviews and confirms the contents of the word for the ship, checks the safety of the workplace, classifies cargoes into general cargoes and special cargoes to instruct the equipment operators to load and unload the cargoes, proceeds with the work after taking an action for damaged cargoes, wirelessly communicates with the operator of the equipment and the control man in the terminal control center to announce the work situation, reports on the work situation to the foreman, confirms the work content after the work is finished, and fills out a work log book.

The “equipment operator” refers to a “gantry crane operator” or a “container crane operator.” The “gantry crane operator (the equipment operator)” checks the quantity and size of the containers to be unloaded, operates the gantry crane control device to move containers, and operates the adjustment lever and switch of the crane according to the signal from the signalman to load the container on a ship or a vehicle, and checks and repairs the crane to prevent accidents.

The “container crane operator” checks the quantity and size of containers to be loaded and unloaded, operates the adjustment device to lower the crane on a ship's deck or a vehicle, and “operates the adjustment lever and the panel to lift the container from the ship and moves the container onto the deck or a vehicle, lowers the crane to a place of loading or unloading according to the signal from the signalman and, operates the adjustment device to load the container on a ship or a vehicle, and operates a reach stacker, which is a vehicle for moving containers from the berth to the yard.

The “operation inspector” includes a container inspector and a ship container manager. The container inspector checks the actual container loading/unloading position with reference to the stowage plan, checks presence of another cargo loaded on the unloaded cargo, and checks if a cable is plugged in a frozen cargo to check the temperature meter. If cargoes are different from the stowage plan, the container inspector reports the difference to the chief inspector. When working in the yard on the land, the container inspector checks the container number and the seal number and records the same in an inspection table. If a cargo that is not sealed is found, the container inspector delivers a report to the cargo owner, re-seals the cargo in the presence of customs officers, and checks container damage. In the case of an imported cargo, the seal is opened with the cargo company attending in accordance with the list of loaded cargoes, and fills out the inspection table. In the case where there is abnormality such as a damage or a shortage in quantity, the container inspector reports the abnormality to the customs and the shipping company. In the case of an exported item, the container inspector checks the quantity of the exported cargoes, the packaging state, and presence of abnormality or recognizes a mixed cargo and reports the same, and keeps proof of facts in an inspection table

The container officer (operation personnel) reviews the contents of work for each ship line, receives unloading documents such as various stowage plans (drawings showing the arrangement of cargoes loaded on the dock of the ship) and a work order, reviews the contents of the documents, copies and distributes the contents, checks the contents of the work documents and the actual number of containers, changes the location of the cargo on the ship, corrects details of work such as sizes different to the actual details, checks the quantity, sizes and contents of unloaded or loaded containers, computerizes the locations of the containers, computationally processes shipment addition or cancellation, creates a process situation report and a container list, negotiate necessary matters such as change of the work and the ship schedule with the shipping company, checks the documents and work quantity submitted by the under man after completion of work, and creates a work status report.

In addition, there are also a signalman, a container equipment dispatcher, and a container berth control center control man. The signalman makes a list of work order by identifying the work order and field process (logistics), checks the type, weight, location, and route of movement of a cargo to be moved, and presence of an obstacle on the route, assists movement of the cargo by transmitting a radio signal and a flag signal to various equipment operators (under man, signalman, foreman, container crane driver, yard tractor driver) depending on the type of equipment and cargo, check the obstacles on the rail line and sends a drive signal when the container crane is driven, arranges cars under the container crane and limits the speed, and also specifies the ride and get-off locations and sends a start signal to the yard tractor driver.

The container equipment dispatcher establishes plans according to request for use of container terminal equipment such as gantry cranes, shift cranes, rich stackers, yard tractors, and MT handlers, records dispatching instructions, manages driving logs, organize the use of equipment, maintain equipment inspection and preventive maintenance, equipment dispatch and operation statistics, identifies the operation status of equipment operators, and conduct safety training for equipment operators.

The container berth control center (C/C) control man identifies the amount of work to be performed on the day, receives a list of the containers to be imported, control gate in and out in consultation with the carrier and the shipping company according to the situation of the yard, monitors the situation through computer, checks whether the planned work is performed, prepares alternatives if there is a problem, communicates with the foreman, the under man, and the gatekeeper by wire or wirelessly, orders work, sends the situation, requests equipment dispatch and corrects the device position by checking the work change status.

Now, a system and method for providing an integrated stowage plan using a cloud service according to another aspect of the present invention will be described with reference to FIGS. 6 to 12E.

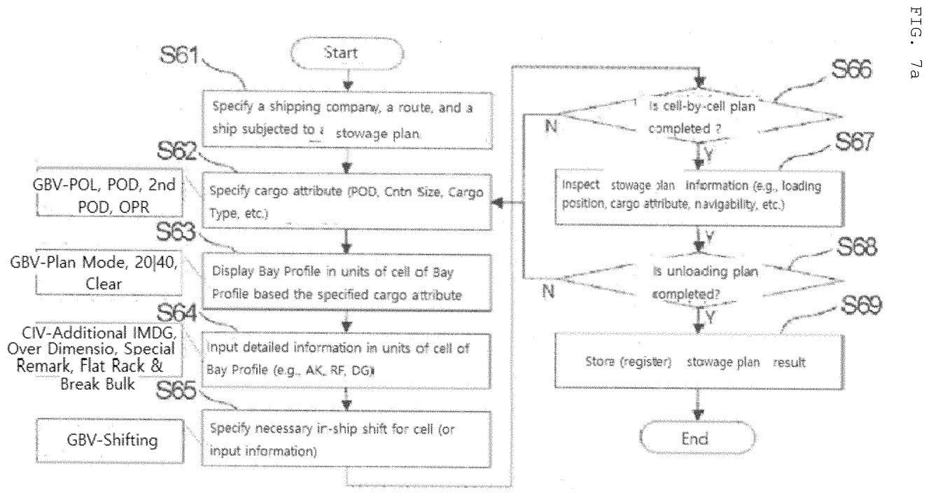

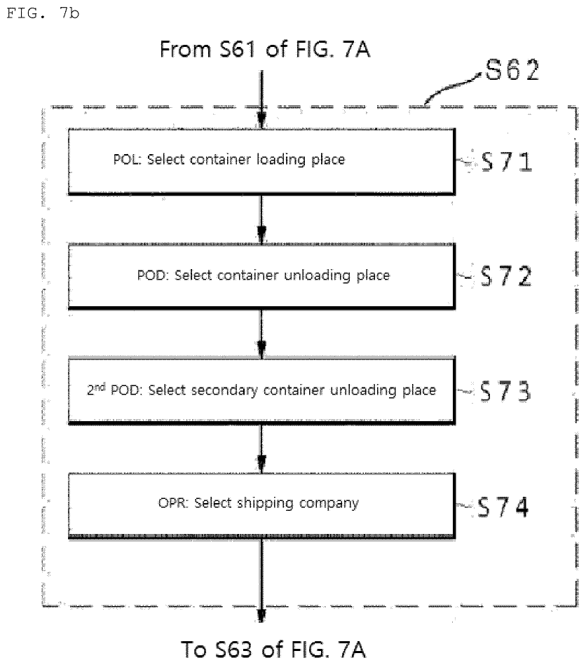

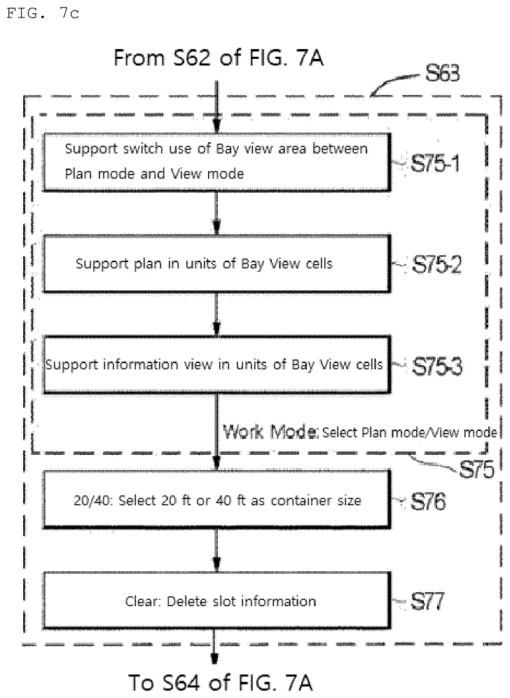

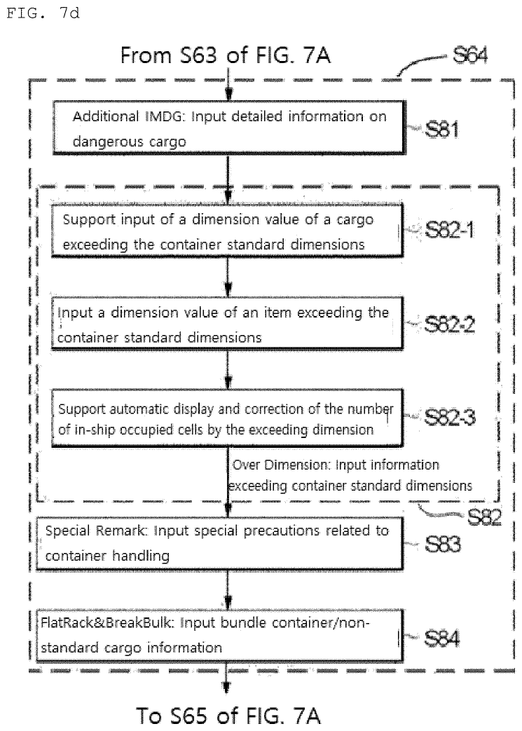

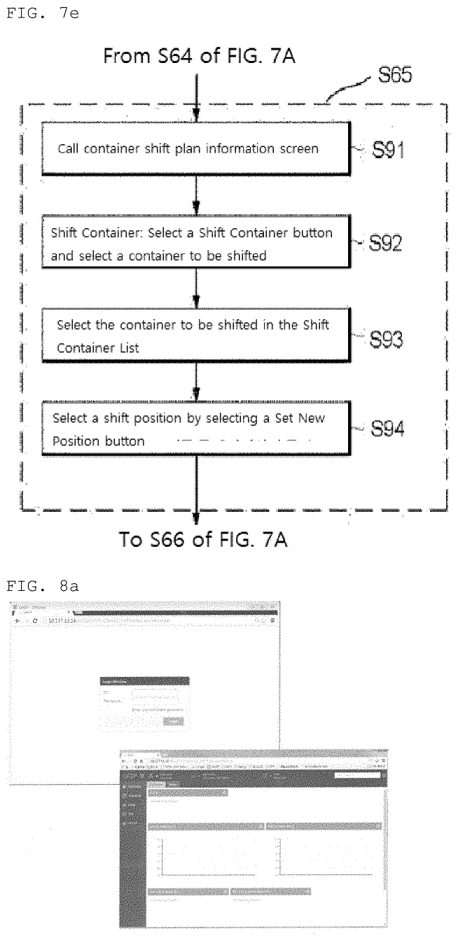

FIG. 6 is a diagram illustrating a flow of unloading & loading according to a system for providing an integrated stowage plan using a cloud service according to another aspect of the present invention. FIG. 7A is a flowchart illustrating a method for providing an integrated stowage plan using a cloud service according to another aspect of the present invention. FIG. 7B is a detailed flowchart of a cargo attribute designation step S62 of FIG. 7A, FIG. 7C is a detailed flowchart of a cargo attribute display step S63 of FIG. 7A, FIG. 7D is a detailed flowchart of a detailed information input step S64 of FIG. 7A, and FIG. 7E is a detailed flowchart of a shift plan designation step S65 of FIG. 7A.

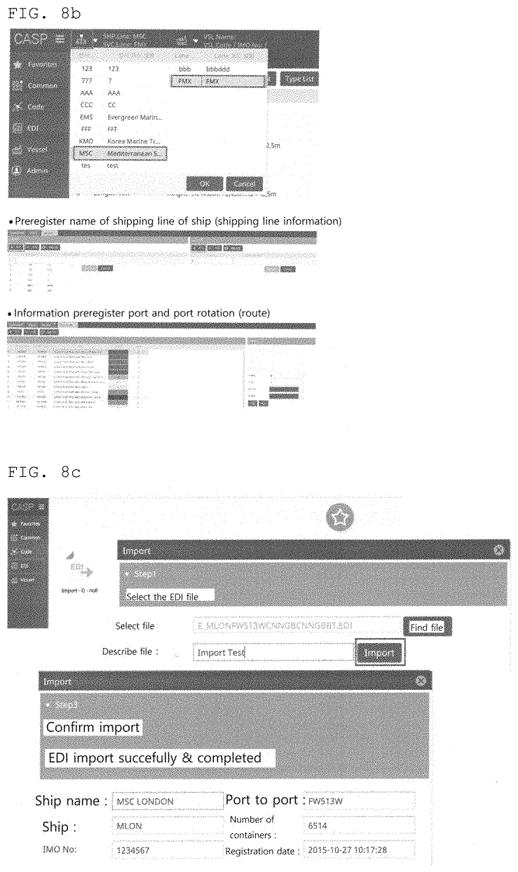

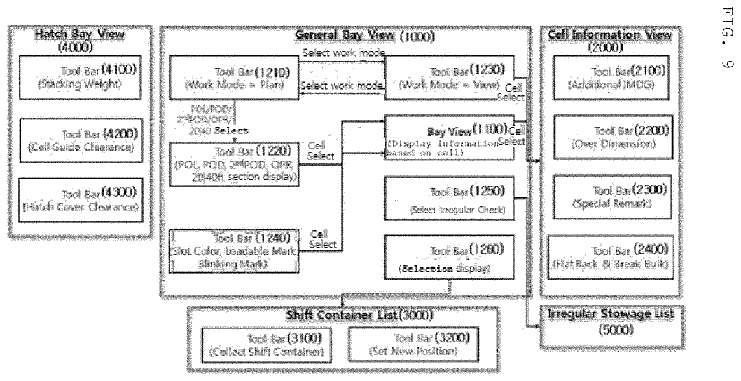

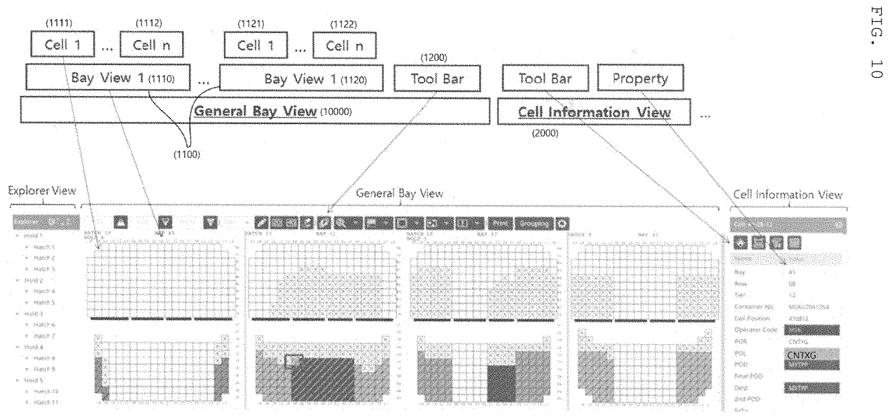

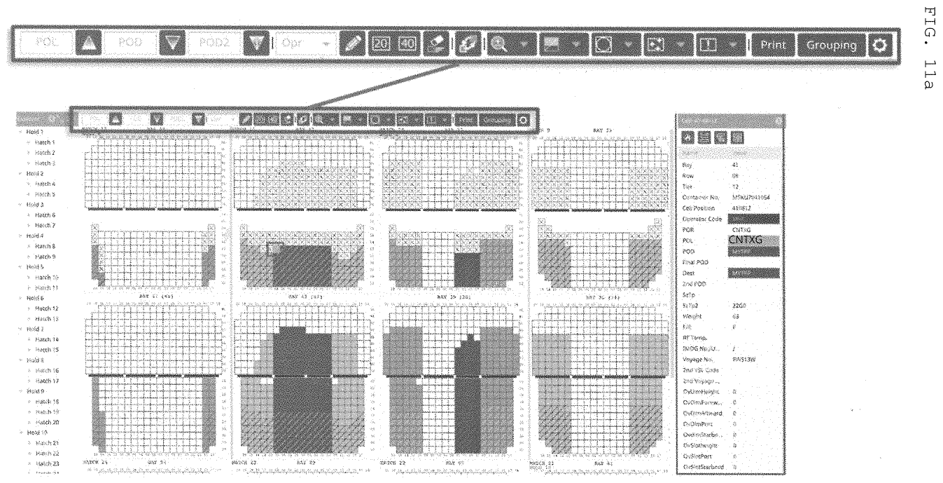

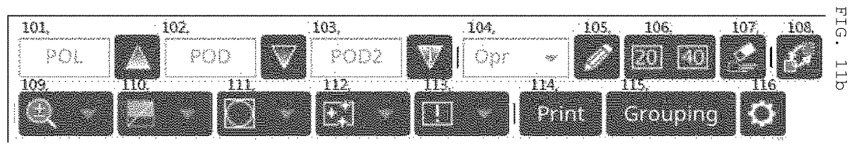

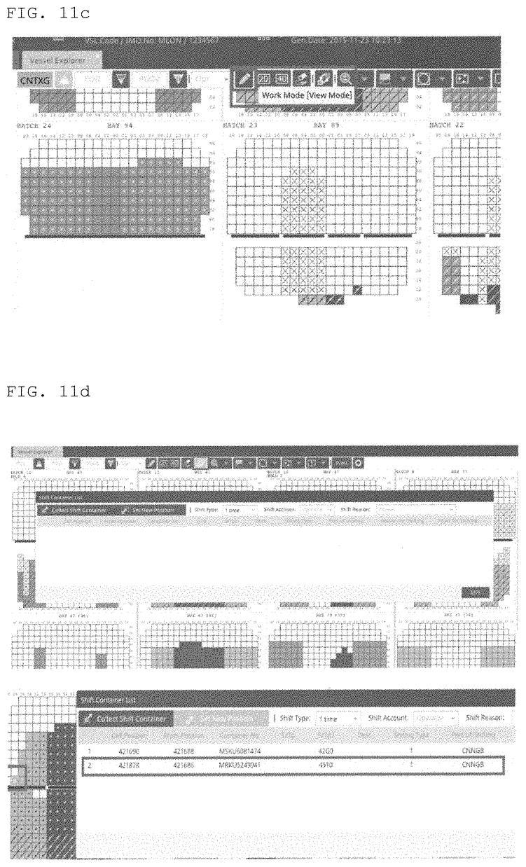

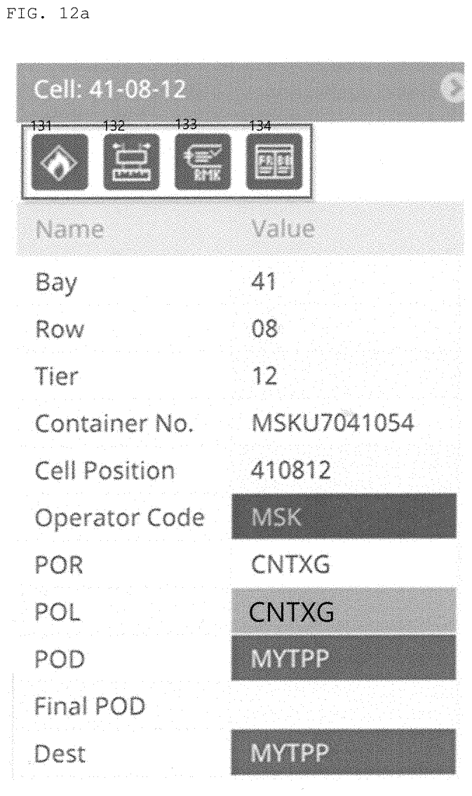

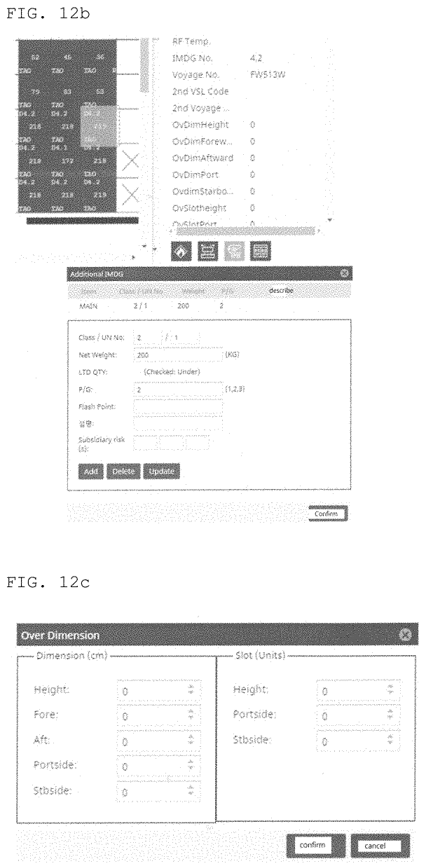

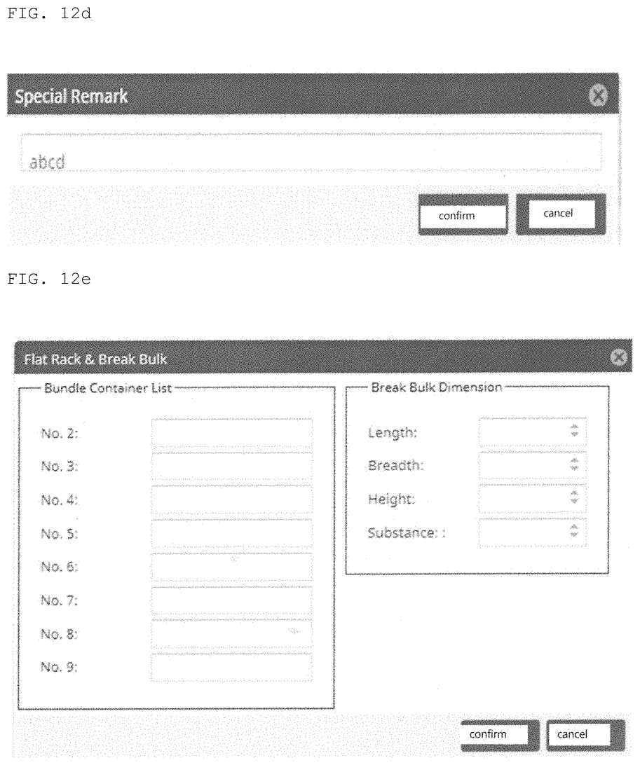

FIGS. 8A to 8C show an example of a preliminary preparation step in an actual screen configuration of a system for providing an integrated stowage plan using a cloud service according to an aspect of the present invention, and FIG. 9 is a functional block diagram illustrating respective windows for a stowage plan in a system for providing an integrated stowage plan using a cloud service according to another aspect of the present invention. FIG. 10 is a diagram illustrating a module hierarchy for respective windows for a stowage plan in a system for providing an integrated stowage plan using a cloud service according to another aspect of the present invention. FIGS. 11A to 11D are detailed views illustrating each step for GBV of FIG. 10. FIGS. 12A to 12E are detailed views illustrating each step for CIV of FIG. 10.

Referring to FIG. 6, a description will be made of an unloading flow according to the integrated stowage plan providing system 200 using a cloud service according to another aspect of the present invention from the view point of the planners. In this structure, a plurality of planners 140 and 140′ is allowed to simultaneously operate based on difference in port between ships. Specifically, the SPCS system provides:

1. a standard code information providing service through the server 200;

2. a ship's route information providing service through the server 200;

3. a ship's specification information providing service through the server 200;

4. an EDI transmission/reception service through the server 200;

5. specifying the shipping company subjected to stowage, the route and the ship through each planner (planner #1 (140), planner #2 (140′);

6. Specifying, by each planner 140 or 140′, the edit attribute in consideration of the loading target cargo attribute (for example, POD, Cntr Size, Cargo Type, etc.);

7. displaying, by each planner 140 or 140′, the specified cargo attribute reference for each cell of the bay Profile;

8. Inputting, by each planner 140 or 140′, detailed information in units of cells of the bay Profile (e.g., by AK, RF, DG, BB, etc.);

9. In the case where an in-ship shift is needed in cell-based work, specifying, by each planner 140, 140′, a shift plan to the corresponding cell;

10. Repeating, by each planner 140, 140′, the above item 6 when the cell-based planning is not completed,

11. carrying out, by each planner 140, 140′, inspection of the cargo plan information (e.g., loading position, cargo attributes, navigability, etc.) and carrying out the above item 6 if there is a problem in the inspection; and

12. storing (registering), by each planner 140, 140′, the results after the planning work progresses.

Referring to FIG. 7A, the stowage planning process of the service system server 200 and the users (planners) 140 and 140′ provided by the stowage planning cloud service is described below again.

Steps S61 to S69 are performed while the SPCS system provides standard code information, ship route information, ship specification information, and an EDI transmission/reception service. Steps S61 to S69 include:

(a) specifying, by each of the planners, a shipping company, a route, and a ship subjected to a stowage plan (S61);

(b) specifying, by each of the planners, an editing attribute in consideration of the attributes (e.g. POD, Cntr Size, Cargo Type, etc.) of a cargo to be loaded (S62);

(c) displaying (specifying/unspecifying), by each of the planners, a bay profile in units of a cell of the bay profile based the specified cargo attribute (S63);

when input of detailed information is needed in units of the cell of the bay profile, inputting and processing, by each of the planners, detailed information (e.g., AK, RF, DG, BB, etc.) (S64);

(e) when in-ship shift is needed during work in units of the cells, specifying, by each of the planners, a shift plan in a corresponding cell (S65);

(f) determining, by each of the planners, whether or not a cell-by-cell plan has been completed (S66) and repeating the operations from the step S62 when the plan has not been completed;

(g) inspecting stowage plan information when the plan has been completed (S67);

(h) determining whether there is a problem in the inspection (whether the stowage plan has been completed) (S68), and repeating the operations from the step S62 when there is a problem (the stowage plan has not been completed); and

(i) storing and registering, by each of the planners, a result of execution of planned when there is no problem in the step (h) (the stowage plan has been completed) (S69).

FIGS. 8A to 8C are views showing an example of a preliminary preparation step among actual screen configurations of a system for providing an integrated stowage plan using a cloud service according to an aspect of the present invention. FIG. 8A shows a screen configuration for logging in after a web connection, FIG. 8B shows a screen for additionally registering the ship line and route through the upper menu. In the upper menu at the top, the route ship line and data selection screen, the ship line name information pre-registration screen of the ship are shown. FIG. 8C shows a function corresponding to the “Load/Save Stowage Plan”, and includes “EDI Import” and “EDI Export”.

The steps (b) to (e) will be described in detail with reference to FIGS. 7B to 7E and FIGS. 11A to 12E.

Referring to FIGS. 7A and 7B, the step b of specifying attributes of a cargo to be loaded includes (b1) selecting a container loading place (S71 in FIG. 7B), (b2) selecting a container unloading place (Step S72 in FIG. 7B), (b3) selecting a secondary container unloading place (S73 in FIG. 7B), and (b4) selecting a shipping company (S74 in FIG. 7B) (see 101 to 104 in FIG. 11B).

Referring to FIGS. 7A to 7C, the step c of displaying cargo attributes in units of cells (S63) includes (c1) selecting a Plan work mode or a View work mode (step S75 in FIG. 7C), (c2) selecting a size of a container, for example, 20 ft or 40 ft (S76 in FIG. 7C), and (c3) deleting slot information (S77 in FIG. 7C) (see 105 to 107 in FIG. 11B). The step (c1) again includes supporting switch use of a bay view area between the Plan mode and the View mode (S75-1), supporting a plan in units of bay view cells (S75-2), and supporting, in the View mode, an information view in units of bay view cells and displaying “Cell Information View” (S75-3) (see FIG. 11).

Referring to FIGS. 7A and 7D, the step d of inputting detailed information in units of cells (S64) includes (d1) inputting detailed information on a dangerous cargo (S81 of FIG. 7D), and the container information of the (d2) inputting information exceeding container standard dimensions (S82 in FIG. 7D), (d3) inputting special precautions related to container handling (S83 in FIG. 7D), and (d4) inputting bundle container and non-standard cargo information (S84 in FIG. 7D) (see 131 to 134 in FIG. 12A). Here, the step (d1) supports input of detailed information on the dangerous cargo among the container freights according to the IMDG/UNNO standard and supports the functions of addition/deletion/modification of the information on the individual dangerous cargoes inside the container through the ‘Add’, ‘Delete’, ‘Update’ buttons (see FIG. 12B). In addition, the step (d2) again includes supporting input of a dimension value of a cargo exceeding the container standard dimensions (S82-1), inputting, in a “Dimension” field, a dimension value of an item exceeding the container standard dimensions (S82-2), and supporting, in a “Slot (Units)” field, automatic display and correction of the number of in-ship occupied cells (slots) by the exceeding dimension (S82-3) (see FIG. 12C). The “Special Remark” menu of step d3 supports inputting of special precautions related to container handling (see FIG. 12D), and the ‘Flat Rack & Break Bulk’ menu of step d4 supports inputting of a plurality of container names of a bundle container or external dimensions of the cargo (see FIG. 12E).

Finally, referring to FIGS. 7A and 7E, the step e of specifying the cell-based shift plan includes (e1) calling a container shift plan information screen (Shift Container List) (S91 in FIG. 7E), (e2) selecting a Collect Shift Container button and selecting a container to be shifted (S92 of FIG. 7E), (e3) selecting the container to be shifted in the Shift Container List (S93 of FIG. 7E), and (e4) selecting a shift position by selecting a Set New Position button (S94 in FIG. 7E) (see FIG. 12D).

Referring FIGS. 9 to 11D, the overall functional configuration of each window in the stowage plan according to another aspect of the present invention includes a general bay view (GBV) 1000, a cell information view (CIV) 2000, a shift container list (SCL) 3000 and a hatch bay view (HBV) 4000 (see FIG. 9).

The GBV 1000 includes bay view (bay View 1′ to bay view n′) 1110 to 1120 and various tool bars 1200 (1210 to 1260). The bay view 1 1110 corresponds to a plurality of cells (Cell 1′ to Cell n′) 1111 to 1112 (see FIG. 10). In addition, the tool bar 1200 includes a work mode toolbar 1210 for selecting a plan mode, a work mode toolbar 1230 for selecting a view mode, various selection toolbar 1220, a color of a slot, an indication of loadability, a toolbar 1240 indicated by, for example, blinking, or the like, an irregular check toolbar 1250 and a shift selection toolbar 1260.

As shown in FIG. 11A, various tool bars 1200 and various bay views 1110 are displayed. In each bay view, a plurality of cells 1111 to 1212 is partitioned and displayed.

FIG. 11B shows a set of such various tool bars. The operation of the subroutine in FIG. 7B is performed through the container shipping place selection (POL) 101, the container unloading place selection (POD) 102, selection of secondary container unloading place (2nd POD) (103) and shipping company selection (OPR)(104). In FIG. 7C, the operation of the subroutine is performed through toolbars for selecting the plan/view mode 105, selecting 20 ft or 40 ft container size 106, and deleting slot information (107).

For reference, in FIG. 11B, reference numeral 108 denotes a Zoom (information screen enlargement/reduction support) tool bar, 110 denotes a cell Color (this division) color display reference toolbar, 111 denotes a Loadable Mark tool bar (for marking shipping allowed position of a specific container), ‘112’ denotes a tool bar for Blinking Mark (marking for easy identification of a specific container), ‘113’ is a toolbar for Irregular Check (for viewing a list of unacceptable containers/cargoes based on the cell of the ship), ‘114’ is a tool bar for printing (supporting information output through the printer), ‘115’ is a tooling for grouping (support for specifying between groups between bays), and ‘116’ is a configuration toolbar (for bay information display setting).

The ‘Zoom’ menu provides options of −20%, 100%, and +20%. When ‘−20%’ or ‘+20%’ option is selected among the options, the screen information which is reduced or enlarged by the corresponding ratio is displayed. When the ‘100%’ item is selected, the screen information is displayed by the ratio of the original size. The ‘cell color’ menu provides options such as POD, POL, OPR, POD+POL. When selecting the option item, the cell color is displayed based on the information of each cell based on the selected item. Port-specific color information refers to color information set in Port Rotation. ‘Loadable Mark’ menu provides options of Clear Mark, 45 ft size, 48 ft size, 53 ft size, Reefer Receptacle. ‘0’ is indicated for the loadable cells included in the condition of the selected item based on the container attribute. If Clear Mark is selected, the displayed Loadable Mark disappears. The ‘Blinking Mark’ menu provides options of Clear Blinking, Special Remark, Re-stowing Containers, BB and AK Cargo. When the option item is selected, the cells included in the condition of the selected item among the container properties are displayed in blue and blinking is performed. If the ‘Clear Blinking’ option is selected, all information that is blinking will be erased. The ‘Irregular Check’ menu provides Reefer Receptacle, Duplicated Container No, Incorrect Container No, Container SzTp, Incorrect Position, and Option. When the option item is selected, Irregular data included in the corresponding item are displayed in separate Grid. When ‘Clear Mark’ is selected, the displayed Loadable Mark is cleared.

It will be apparent to those skilled in the art that various modifications and variations can be made in the present invention without departing from the spirit and scope of the invention. Thus, it is intended that the present invention cover the modifications and variations of this invention provided they come within the scope of the appended claims and their equivalents.

1. A system for providing an integrated stowage plan using a stowage planning cloud service (SPCS), the system comprising:
a server of an SPCS system for providing standard code information, ship route information, ship specification information, and an EDI transmission/reception service;
a first planner connected to the server via a web browser or mobile device; and
a second planner different from the first planner connected to the server via a web browser or mobile device,
wherein each of the first planner and the second planner performs a series of operations comprising:
(a) specifying a shipping company, a route, and a ship subjected to a stowage plan;
(b) specifying, by each of the planners, an editing attribute considering attributes of a cargo to be loaded;
(c) displaying, by each of the planners, a bay profile in units of a cell of the bay profile based the specified cargo attribute;
(d) when input of detailed information is needed in units of the cell of the bay profile, inputting and processing, by each of the planners, detailed information;
(e) when in-ship shift is needed during work in units of the cells, specifying, by each of the planners, a shift plan in a corresponding cell;
(f) determining, by each of the planners, whether or not a cell-by-cell plan has been completed;
(g) repeating the operations (a) through (f) when the plan has not been completed, and inspecting stowage plan information when the plan has been completed;
(h) determining whether there is a problem in the inspection when the plan has been completed; and
(i) repeating the operations (a) through (h) when there is a problem in operation (h), and storing and registering, by each of the planners, a result of planned execution when there is no problem in operation (h).

2. A method for providing an integrated stowage plan using a stowage planning cloud service (SPCS) system including a server and a plurality of planners, in the state where the server of the SPCS system has provided standard code information, ship route information, ship specification information, and an EDI transmission/reception service, the method comprising the operations:
(a) specifying, by each of the planners, a shipping company, a route, and a ship subjected to a stowage plan;
(b) specifying, by each of the planners, an editing attribute considering an attribute of a cargo to be loaded;
(c) displaying, by each of the planners, a bay profile in units of a cell of the bay profile based the specified cargo attribute;
(d) when input of detailed information is needed in units of the cell of the bay profile, inputting and processing, by each of the planners, detailed information;
(e) when in-ship shift is needed during work in units of the cells, specifying, by each of the planners, a shift plan in a corresponding cell;
(f) determining, by each of the planners, whether or not a cell-by-cell plan has been completed;
(g) repeating operations (a) through (f) when the plan has not been completed according to operation (f), and inspecting, by each of the planners, stowage plan information when the plan has been completed according to operation (h);
(h) determining whether there is a problem in the inspection; and
(i) repeating the operations (a) through (h) when there is a problem in operation (h), and storing and registering, by each of the planners, a result of planned execution when there is no problem in operation (h).

3. The method according to claim 2, wherein operation (b), comprises:
(b1) selecting a container loading place;
(b2) selecting a container unloading place;
(b3) selecting a secondary container unloading place; and
(b4) selecting a shipping company.

4. The method according to claim 2, wherein the operation (c), comprises:
(c1) selecting a plan work mode or a view work mode;
(c2) selecting a size of a container; and
(c3) deleting slot information.

5. The method according to claim 4, wherein the operation (c1) comprises:
supporting switch in use of a bay view area between the plan mode and the view mode;
supporting a plan in units of bay view cells;
supporting, in the view mode, an information view in units of bay view cells and displaying a “cell information view”.

6. The method according to claim 2, wherein the operation (d), comprises:
(d1) inputting detailed information on a dangerous cargo;
(d2) inputting information exceeding container standard dimensions;
(d3) inputting special precautions related to container handling; and
(d4) inputting bundle container and non-standard cargo information.

7. The method according to claim 6, wherein the operation (d2) comprises:
supporting input of an exceeded dimension value of a cargo exceeding the container standard dimensions;
inputting, in a “Dimension” field, an exceeded dimension value of an item exceeding the container standard dimensions; and
supporting, in a “Slot (Units)” field, automatic display and correction of the number of in-ship occupied cells (slots) by the exceeded dimension.

8. The method according to claim 2, wherein the operation (e) comprises:
(e1) calling a container shift plan information screen (shift container list);
(e2) selecting a collect shift container button and selecting a container to be shifted;
(e3) selecting the container to be shifted in the shift container list; and
(e4) selecting a shift position by selecting a set new position button.

9. A system for providing an integrated stowage plan using a cloud service, the system comprising:
a first stowage plan execution group for executing a stowage plan, comprising a master planner terminal of a shipping company, a chief officer terminal, a chief inspector terminal of an inspection company, an operation planner terminal of a container terminal, an operation personnel terminal of the container terminal, and an equipment operator terminal of the container terminal and an operation inspector terminal of the inspection company;
a plurality of stowage plan execution groups having the same configuration as the first stowage plan execution group; and
a cloud service server configured to collect stowage plans transmitted from the first stowage plan execution group and the plurality of stowage plan execution groups and provide a predetermined integrated stowage plan related to loading of a container such that the stowage plans executed at each port and data according to the execution can be shared and utilized.

10. The system according to claim 9, wherein at least one of the stowage plan execution groups implements a method for providing an integrated stowage plan using a cloud service using an stowage planning cloud service (SPCS) including a terminal operating system (TOS).

11. A method for providing an integrated stowage plan using a cloud service using a stowage planning cloud service (SPCS), the method comprising the operations:
(a) registering, in the SPCS, a “stowage plan” established by a shipping company planner based on a container transportation reservation from a master planner terminal;
(b) receiving review and correction for a special cargo to be unloaded input by a chief inspector in the SPCS, from a chief inspector terminal;
(c) receiving, from a chief officer terminal, an input result of review of navigation stability of a ship and a shipping position by a chief officer in the SPCS;
(f) registering the “stowage plan” determined by a chief inspector in the SPCS;
(g) establishing and registering an “unloading & loading work plan” from the “stowage plan” in the SPCS by a terminal planner from an operation planner terminal after the operation (f);
(h) supporting an operation personnel terminal such that operation personnel and equipment operators can perform unloading and loading work based on the “unloading & loading work plan” using a terminal operating system (TOS);
(i) supporting an operation inspector terminal to allow inspectors to inspect individual unloaded/loaded containers and to register individual “unloading & loading work results” in the SPCS, and notifying the chief inspector terminal of the results; and
(j) supporting the operation inspector terminal to register a result of collection and organization of the “unloading & loading work results” by the chief inspector in the SPCS and notifying a chief officer terminal and the master planner terminal of the registration.

12. The method according to claim 11, further comprising:
(d) checking whether loading position adjustment is needed after operation (c), wherein:
when it is determined that the adjustment is needed as a result of the determination in the operation (d), the method returns to the operation (b), and
when it is determined that the adjustment is not needed, the method proceeds to a next operation.

13. The method according to claim 12, further comprising:
(e) determining whether or not there is a cargo that cannot be shipped after operation the (d)), wherein:
when it is determined that there is a cargo that cannot be shipped, method returns to operation (a), and
when it is determined that there is no cargo that cannot be shipped, the method proceeds to a next operation.
